(19) United States
(12) Patent Application Publication
(10) Pub. No.: US 2025/0346742 A1
(43) Pub. Date: Nov. 13, 2025

(54) STARCH SLURRIES, SYSTEMS AND METHODS OF MAKING STARCH SLURRIES, AND SYSTEMS AND METHODS OF MAKING INSULATED PRODUCTS USING STARCH SLURRIES

(71) Applicant: TemperPack Technologies, Inc., Richmond, VA (US)

(72) Inventors: Charles-Alexandre Archambault Vincent, Richmond, VA (US); James McGoff, Richmond, VA (US); Michael Scipione, Richmond, VA (US); John C.S. Hall, Richmond, VA (US); Paul A. Altieri, Skillman, NJ (US)

(21) Appl. No.: 19/202,816

(22) Filed: May 8, 2025

Related U.S. Application Data
(60) Provisional application No. 63/644,621, filed on May 9, 2024.
(60) Provisional application No. 63/644,622, filed on May 9, 2024.
(60) Provisional application No. 63/644,625, filed on May 9, 2024.
(60) Provisional application No. 63/695,811, filed on Sep. 17, 2024.

(51) Int. Cl. C08L 3/02; C08B 30/12; C08J 9/00; C08J 9/14; C08K 5/053; C09D 7/63; C09D 7/65; C09D 103/02

(52) U.S. Cl. CPC C08L 3/02; C08B 30/12; C08J 9/0061; C08J 9/14; C08K 5/053; C09D 7/63; C09D 7/65; C09D 103/02; C08J 2303/02; C08J 2429/04; C08J 2429/14; C08J 2467/02; C08J 2467/04; C08L 2201/50; C08L 2203/14; C08L 2205/06; C08L 2205/24

(57) ABSTRACT

A starch slurry includes a starch in an amount of between approximately 25 to 98 weight percent, a plasticizer in an amount of between approximately 3 to 30 weight percent, and water in an amount of between approximately 5 to 60 weight percent. The starch slurry can have a bulk density of between approximately 10 to 100 pounds per cubic foot. The starch slurry can be used for generating insulation products or printing a starch foam.

### CROSS-REFERENCE TO RELATED APPLICATIONS

This application claims priority under 35 U.S.C. § 119 to U.S. Provisional Patent Application No. 63/644,621, filed May 9, 2024, entitled “METHOD OF MAKING FOAM FOR PACKAGING,” U.S. Provisional Patent Application No. 63/644,622, filed May 9, 2024, entitled “METHOD OF MAKING FOAM FOR PACKAGING,” U.S. Provisional Patent Application No. 63/644,625, filed May 9, 2024, entitled “METHOD OF MAKING FOAM FOR PACKAGING,” and U.S. Provisional Patent Application No. 63/695,811, filed Sep. 17, 2024, entitled “INSULATED OR CUSHIONING PANELS AND METHODS AND SYSTEMS FOR MAKING INSULATED OR CUSHIONING PANELS,” the entire contents of each of which are fully incorporated herein by reference.

### FIELD

The presently disclosed subject matter generally relates to starch slurries, systems and methods of making starch slurries, and systems and methods of making insulated products using starch slurries.

### BACKGROUND

Insulation materials have long been used in a variety of applications and are being increasingly used in insulated shipping containers to provide desired or required thermal environments when shipping goods. For example, an insulated shipping container transporting perishable goods (e.g., refrigerated meals) may increase the longevity of the goods and, in turn, expand the shipping area of the customer base. While some insulated shipping containers are designed for long term use, such as petroleum-derived foams, others are designed for a more limited lifespan in favor of lower materials and manufacturing costs. Similarly, cushioning materials used for protective packaging applications, which may include insulation materials, may also have limited life spans. While these limited lifespan shipping containers practically serve their intended purpose, the ever-increasing volume of shipping containers or parts results in higher levels of waste, most of which is non-recyclable nor compostable at least in part because the insulation materials or cushioning materials are often non-recyclable. Some examples include petroleum-derived foams such as expanded polystyrene, polyurethane, polyethylene, etc. Environmentally conscious retailers and consumers are faced with limited environmentally friendly and responsible options, much less cost-effective options, for disposing insulation or cushioning materials or insulated or cushioning shipping containers following use.

When producing foam for insulation or protective materials, extruders are often used. However, extruders are capital-intensive and cannot be used to create three dimensional shapes, e.g., corner protectors, because they are limited to controlling expansion in only two dimensions. Additionally, extruders have a maximum width that is easily reached when extruding sheets of foam. Finally, it is often difficult, if not impossible, to obtain a consistent layer of foam of desired thicknesses using an extruder at an economic scale. In some cases, it is often difficult, if not impossible, to extrude a layer of foam of more than 0.50″ thickness at scale and of reasonable bulk density to compete with petroleum alternatives.

Accordingly, there is a need for improved starch slurries, systems and methods of making starch slurries, and systems and methods of making insulated products using starch slurries. Embodiments of the present disclosure are directed to this and other considerations.

### SUMMARY

Briefly described, embodiments of the presently disclosed subject matter relate to starch slurries, systems and methods of making starch slurries, and systems and methods of making insulated products using starch slurries.

In one aspect of the invention, a starch slurry is disclosed. The starch slurry has a bulk density of between approximately 10 to 100 pounds per cubic foot (lbs./ft³), such as between 20 to 80 lbs./ft³, or between 30 to 60 lbs./ft³. The starch slurry includes a starch in an amount of between approximately 25 to 98 weight percent, a plasticizer in an amount of between approximately 3 to 30 weight percent, and water in an amount of between approximately 5 to 60 weight percent. The starch slurry may further include one or more agents in an amount of between approximately 1 to 10 weight percent.

In another aspect of the invention, a method of making an insulation part is disclosed. The method may include mixing at least a starch, a plasticizer, and water, and in some embodiments other agents depending on the desired part properties together to form a starch slurry. The method may include depositing the starch slurry onto a substrate, and expanding the starch slurry to create a continuous or discontinuous foam layer on the substrate.

In another aspect of the invention, a method of depositing a starch foam is disclosed. The method may include mixing at least a starch, a plasticizer, and water together to form a starch slurry. The method may include causing the starch slurry to flow into one or more vessels. The method may include actuating one or more movable components of the one or more vessels thereby extruding the starch slurry through one or more apertures of the one or more vessels to generate a starch foam. The method may include moving at least a portion of the one or more vessels, a substrate, or both to dispose the starch foam in a continuous layer or in a plurality of positions that are spaced apart from one another on the substrate. The method may include expanding the starch slurry into a foam having a bulk density lower than the slurry.

In another aspect of the invention, methods and materials for forming starch slurries into three dimensional starch foam components via molding are disclosed. A method may include introducing the slurry into a mold and then generating a foam that expands to conform to the mold. In some embodiments, the mold may be heated. The method may include transforming the slurry into a foam and then introducing the foam to the mold where it may conform to the shape. In some embodiments, an external gas may by mixed or added to the slurry before injection. The method may further include changing the shape or volume of the mold during processing to form the foam or induce a pressure change in the foam or slurry. The method may include manipulating the atmosphere within the mold via the introduction of a gas or presence of a vacuum.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

FIG. 1 is a flowchart of a method for molding an insulation part, in accordance with an exemplary embodiment.

FIG. 2 is a diagram of an exemplary method and device for fabricating foam insulation, in accordance with an exemplary embodiment.

FIG. 3 is a diagram of an exemplary method and device for fabricating foam insulation, in accordance with an exemplary embodiment.

FIG. 4A is a flowchart of a method for making a foamed product, in accordance with an exemplary embodiment.

FIG. 4B is a flowchart of a method for making a foamed product, in accordance with an exemplary embodiment.

FIG. 5 is a flowchart of a method for making an insulation part, in accordance with an exemplary embodiment.

FIG. 6 is a flowchart of a method for making an insulation part, in accordance with an exemplary embodiment.

FIG. 7 is a flowchart of a method for making an insulation panel, in accordance with an exemplary embodiment.

FIG. 8 is a diagram of an exemplary method and system for fabricating foam insulation, in accordance with an exemplary embodiment.

FIG. 9A is an illustration of an example insulation part, in accordance with an exemplary embodiment.

FIGS. 9B-9D show steps in an exemplary method for forming the insulation part of FIG. 9A into an insulated product, in accordance with an exemplary embodiment.

FIG. 10 is a flowchart of a method for depositing starch foam, in accordance with an exemplary embodiment.

FIG. 11 is a diagram of an exemplary system for printing starch foam, in accordance with an exemplary embodiment.

FIG. 12 is a diagram of certain components of the exemplary system of FIG. 12.

FIG. 13 is a diagram of starch foam printed via the exemplary system of FIG. 12.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive.

Embodiments of the disclosed technology include starch slurries, systems and methods of making starch slurries, and systems and methods of making insulated products using starch slurries. The starch slurries disclosed herein and insulated products formed by the methods disclosed herein have particular applicability in shipping containers, such as those disclosed in U.S. Pat. Nos. 10,357,936, 10,745,187, and 11,701,872, the subject matter of each of which is incorporated herein by reference. For example, embodiments of the starch slurries disclosed herein may be used to form one or more panels and/or flaps of a shipping container. One exemplary advantage of using embodiments of the starch slurries made according to the disclosed methods is that they can be one or more of (or all of) recyclable, and/or curbside recyclable, and/or industrial compostable, and/or home compostable. It should be understood, however, that the resulting starch slurries and insulated products formed through the disclosed methods and systems may also be used in other end products, such as protective packaging (e.g., mailers, corner protectors, cushioning, padding, sleeves, rolled stock, etc.). It should also be understood that the terms “insulation” and “insulated” may be used interchangeably herein, or one term may be used in describing the other. For example, an insulated product (e.g., an insulated bag) may be formed out of one or more insulation parts or materials (e.g., insulation panels), such as those including starch.

Starch typically requires a tremendous amount of energy to expand into a foam. Generally, starch foam is manufactured using an extrusion process (e.g., using twin-screw extrusion), where a specific mixture of starch powder and other micro ingredients are mixed with water and subjected to high pressure and a high amount of mechanical and/or thermal energy. This process can be expensive, complex, and/or require a large manufacturing footprint. The disclosed technology addresses these limitations by providing on-demand starch foam extrusion (e.g., with limited start-up and/or pre-conditioning time). The disclosed technology also provides for a compact manufacturing footprint, increased scalability, simpler machinery, and a less energy-intensive process. Additionally, the disclosed technology can provide for a less capital-intensive process, compared to a conventional single-screw or twin-screw extrusion process, by providing the ability to precisely “print” a starch foam into a pre-determined design and/or pattern, as well as into discrete particulates having different sizes and/or shapes depending on the die characteristics and foam quantity needed.

Referring now to the figures, in which like reference numerals represent like parts, various embodiments of the disclosure will be disclosed in detail. It should be understood that certain embodiments of the disclosed methods may omit one or more blocks as being optional.

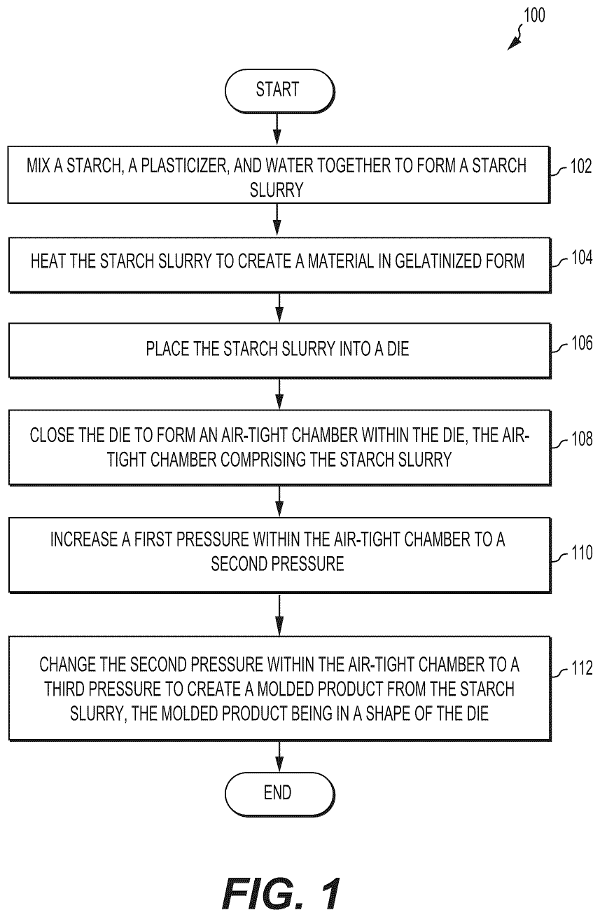

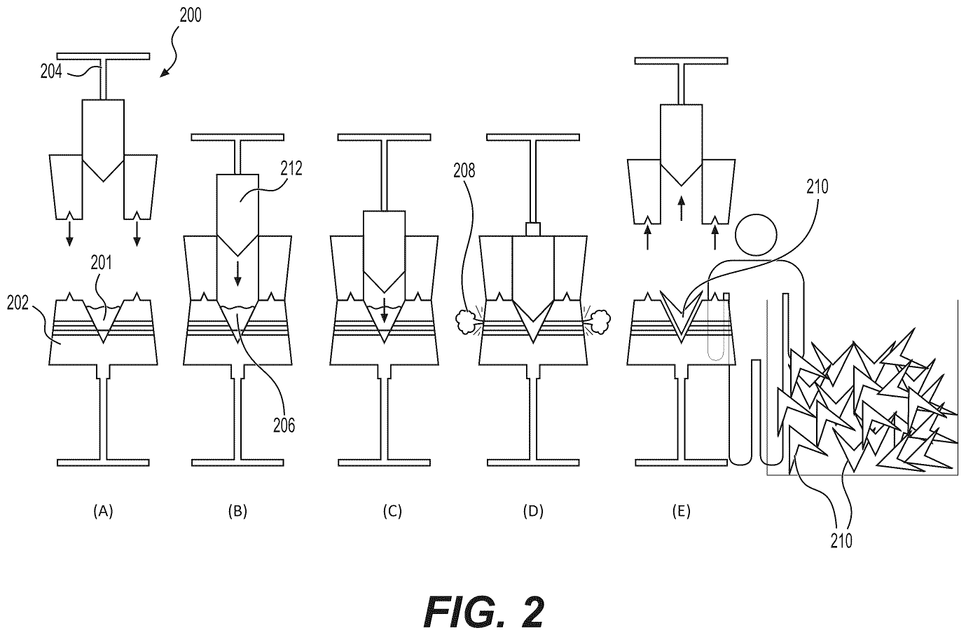

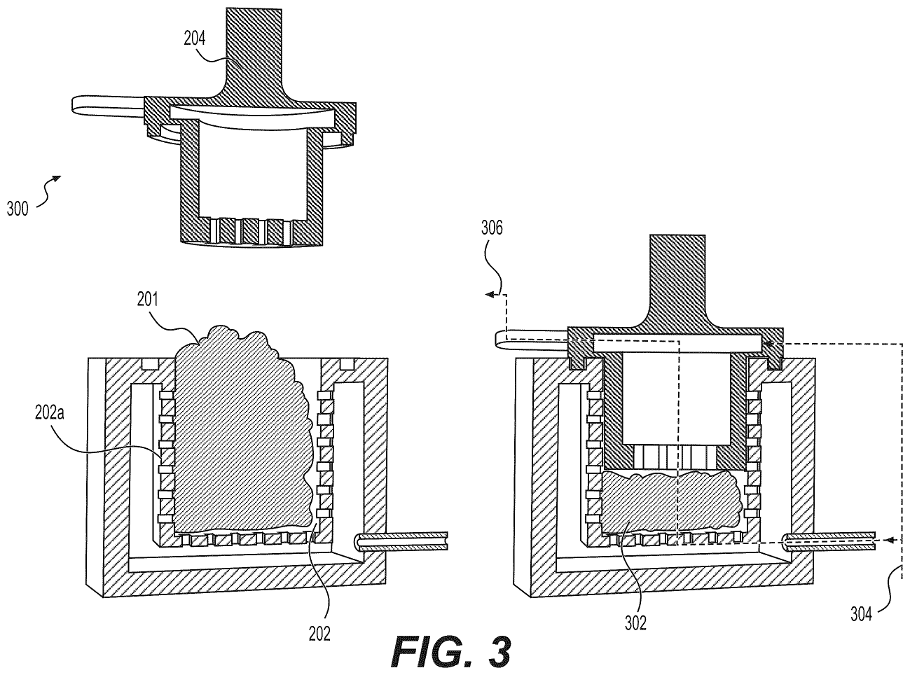

FIG. 1 is a flowchart of a method for fabricating foam, in accordance with an exemplary embodiment. In particular, FIG. 1 shows a method for making foamed insulation without the use of an extruder to directly create foam insulation. FIGS. 2-3 provide diagrams of exemplary systems and associated components for making foamed insulation and will therefore be discussed simultaneously.

In block 102, the method 100 may include mixing (e.g., by agitating) a least a starch, a plasticizer, and water together to form a starch slurry. In some embodiments, one or more other agents are used as described above. The starch may be a root starch, a grain, starch, dent starch, waxy starch, high-amylose starch, chemically substituted starches, and/or sugar. In some embodiments, the starch may include a corn starch having an amylose content above approximately 20 weight percent, such as dent corn or high-amylose corn. Different starches, or a mix of different starches, may be used. The starch can account for between approximately 25 to 98 weight percent of the starch slurry, such as approximately 25 weight percent, 26 weight percent, 27 weight percent, 28 weight percent, 29 weight percent, 30 weight percent, 31 weight percent, 32 weight percent, 33 weight percent, 34 weight percent, 35 weight percent, 36 weight percent, 37 weight percent, 38 weight percent, 39 weight percent, 40 weight percent, 41 weight percent, 42 weight percent, 43 weight percent, 44 weight percent, 45 weight percent, 46 weight percent, 47 weight percent, 48 weight percent, 49 weight percent, 50 weight percent, 51 weight percent, 52 weight percent, 53 weight percent, 54 weight percent, 55 weight percent, 56 weight percent, 57 weight percent, 58 weight percent, 59 weight percent, 60 weight percent, 61 weight percent, 62 weight percent, 63 weight percent, 64 weight percent, 65 weight percent, 66 weight percent, 67 weight percent, 68 weight percent, 69 weight percent, 70 weight percent, 71 weight percent, 72 weight percent, 73 weight percent, 74 weight percent, 75 weight percent, 76 weight percent, 77 weight percent, 78 weight percent, 79 weight percent, 80 weight percent, 81 weight percent, 82 weight percent, 83 weight percent, 84 weight percent, 85 weight percent, 86 weight percent, 87 weight percent, 88 weight percent, 89 weight percent, 90 weight percent, 91 weight percent, 92 weight percent, 93 weight percent, 94 weight percent, 95 weight percent, 96 weight percent, 97 weight percent, 98 weight percent (e.g., between approximately 55 to 95 weight percent) of the mixture.

In some embodiments, the starch may include carbohydrate (e.g., polysaccharides such as starch, including vegetable starch, or cellulose) particulates. In some embodiments, the particulates may include at least about 20% by dry-basis weight starch polysaccharides and the remainder is formed from a mixture of one or more of non-starch polysaccharides, plasticizer, water (e.g., 0 to 20% by weight, specifically about 8 to 12% by weight in some embodiments), colorants, additives, leavening agents, blowing agents, rheology agents, stabilizing agents, additives of cellulosic origin, water-soluble adhesives (e.g., a water-soluble glue, starch, or tacky material, which may be mixed into water or another liquid), hydrophobic agents, nucleating agents, and other inert fillers. In some embodiments, the particulates may include starch by dry-basis weight between about 20% and about 100% starch, including about 95%, about 96%, about 97%, about 98%, about 99% or about 100% starch by dry-basis weight. In other embodiments, particulates can include less than about 95% starch (e.g., vegetable starch), as limiting the weight percentage of starch under 95% helps increase resiliency. In further embodiments, the particulates include no more than about 85% starch (e.g., vegetable starch) to further increase the resiliency of the particulates. The starch content of the particulates may help facilitate it being able to adhere to paper and other materials.

In some embodiments, the plasticizer may be polyvinyl alcohol (PVOH), poly (butylene adipate-co-terephthalate) (PBAT), polyvinyl acetate (PVA), polylactic acid (PLA), polyhydroxyalkanoate (PHA), glycerol, glycerin, and/or one or more gums (e.g., X anthan, Guar). The plasticizer can account for between approximately 3 to 30 weight of the starch slurry (e.g., between approximately 3 to 15 weight percent) of the mixture, for example approximately 3 weight percent, 4 weight percent, 5 weight percent, 6 weight percent, 7 weight percent, 8 weight percent, 9 weight percent, 10 weight percent, 11 weight percent, 12 weight percent, 13 weight percent, 14 weight percent, 15 weight percent, 16 weight percent, 17 weight percent, 18 weight percent, 19 weight percent, 20 weight percent, 21 weight percent, 22 weight percent, 23 weight percent, 24 weight percent, 25 weight percent, 26 weight percent, 27 weight percent, 28 weight percent, 29 weight percent, 30 weight percent).

The water can account for between approximately 5 to 60 weight percent of the starch slurry (e.g., between approximately 7 to 50, between approximately 5 to 15, between approximately 10 to 40, between approximately 20 to 35, between approximately 25 to 30).

In some embodiments, the starch may include starch powder. The starch slurry may be heated below the gelatinization temperature of starch (e.g., the temperature at which the amylopectin within the polysaccharide chain is released) and below the boiling point of water, and stirred into a homogenous slurry.

In some embodiments, the starch slurry may further include one or more agents or additives, such as a leavening agent, a coloring agent, a nucleation agent, a blowing agent, a stabilizing agent, a rheology agent, and/or cellulose (e.g., as a strengthening agent). The starch slurry may include active and/or passive agents, or may be a composite mixture where the additives comprise the balance of the slurry not taken up by starch, plasticizer, or water. The leavening agent may include yeast, sodium bicarbonate, baking soda, and/or baking powder. The coloring agent may include lignin, a food grade die, etc. The nucleation agent may include talc, ash, a Group I or II Carbonate, or other insoluble particulate. In some embodiments, the nucleation agent may be, for example, calcium carbonate, calcium bicarbonate, sodium carbonate, and/or sodium bicarbonate. The blowing agent may include a thermoplastic microsphere, an acrylonitrile copolymer, and/or a vinyl copolymer. The stabilizing agent may include lecithin and/or protein. The rheology agent may include carboxymethyl cellulose (CMC), hydroxypropyl methylcellulose (HPMC), methylcellulose (MC), a gum (e.g., X anthan, Guar), carrageenan, glycerin, glycerol, oils, etc. In some embodiments, an active ingredient, such as a biological precursor of an enzyme, may be added to further react with the starch and produce a gas byproduct, such as carbon dioxide.

In some embodiments, the leavening agent may be between approximately 0 to 35 weight percent (e.g., approximately 0.1 weight percent, 5 weight percent, 10 weight percent, 15 weight percent, 20 weight percent, 25 weight percent, 30 weight percent, 35 weight percent) of the starch slurry. The coloring agent may be between approximately 0 to 5 weight percent (e.g., weight percent, 3 weight percent, 3.5 weight percent, 4 weight percent, 4.5 weight percent, or 5 weight percent) of the starch slurry. The nucleation agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, or 5 weight percent) of the mixture. The blowing agent may be between approximately 0to 8 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent, 5.5 weight percent, 6 weight percent, 6.5 weight percent, 7 weight percent, 7.5 weight percent, or 8 weight percent) of the mixture. The stabilizing agent may be between approximately 0 to 15 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent, 5.5 weight percent, 6 weight percent, 6.5 weight percent, 7 weight percent, 7.5 weight percent, 8 weight percent, 8.5 weight percent, 9 weight percent, 9.5 weight percent, 10 weight percent, 10.5 weight percent, 11 weight percent, 11.5 weight percent, 12 weight percent, 12.5 weight percent, 13 weight percent, 13.5weight percent, 14 weight percent, 14.5 weight percent, or 15 weight percent) of the starch slurry. The rheology agent may be between approximately 0 to 5 weight percent (e.g., approximately 0.1 weight percent, 1 weight percent, 1.5 weight percent, 2 weight percent, 2.5 weight percent, 3 weight percent, 3.5 weight percent, 4 weight percent, 4.5 weight percent, 5 weight percent) of the mixture. The cellulose may be less than approximately 60 weight percent (e.g., less than approximately 55 weight percent, 50 weight percent, 45 weight percent, 40 weight percent, 35 weight percent, 30 weight percent, or 25 weight percent) of the mixture.

In block 104, the method 100 may include heating the mixture to create a material in gelatinized form. In some embodiments the mixture is heated via a hot bath, an oven, or both. Other heating methods such as use of microwaves, radio frequency (RF), convection, and conduction are envisioned. The temperature source (e.g., a heater) may be set to about 1° C. to about 1000° C. such as about 1° C. to about 25° C., about 25° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

Similarly, the mixture may be heated until it reaches an internal temperature of about 1° C. to about 1000° C. such as about 1° C. to about 25° C., about 25° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

In some embodiments, natural fibers (e.g., cellulose) may be incorporated or added to the mixture or the material. Adding the fibers into the mixture or the material before expansion of the material allows the foam to form a composite with the fibers and lock the fibers into place in multiple pockets along the length of the fiber. This adds to the tensile strength of the foam described below. Additionally, and depending on the orientation of the fibers, shear strength of the resultant foam may increase as well.

In some embodiments, the fibers would be mixed into the mixture or material in a random fashion. The multiaxial orientation of the individual fibers would make the overall material stronger in general, however, the fibers could be added in specific directions to optimize the strength of the resulting foam in a desired direction.

The length of the fibers will have a direct impact on the resulting foam properties. Longer fibers tend to interlock more resulting in higher mechanical properties such as strain, tensile and yield strength. However, shorter fibers tend to promote foam expansion compared to longer fibers.

In some embodiments, the starch slurry consists of or essentially consists of starch, plasticizer, and water. In some embodiments, the starch slurry is substantially free of a blowing agent.

In block 106, the method 100 may include placing the starch slurry (or the material) into a die, such as placing starch slurry 201 into die 200 shown in FIG. 2. The die may form any shape (e.g., a cube, a rectangular prism, sphere, a three-dimensional arrow). In some embodiments, the die may include six sides with a gas inlet on a first side and a gas outlet on a second side. In another embodiment, only one gas inlet is used. The first side and the second side may be a same side. In some embodiments, the six sides of the die may interlock to form the air-tight chamber. In some embodiments, the die may include one or more modular parts configured to occupy volume within the air-tight chamber to generate foam of a custom shape. For example, foam may be formed by method 100 using one or more modular parts to create a first part being a side corresponding to a box and changing the one or more modular parts or using different modular parts to form a corner foam insulation piece for a box. Using modular parts (1) allows for the formation of customized foam parts without the need of making or purchasing expensive dies for various different foam parts and (2) avoids damaging the part or die.

In block 108, the method 100 may include closing the die to form an air-tight chamber within the die. For example, a first (upper) portion of the die (204, FIG. 2) may fit into a second (lower) portion of the die (202, FIG. 2) forming the air-tight chamber. In some embodiments, one or more portions of the die may be moved either manually or through a mechanism, e.g., pneumatically, hydraulically, electrically, or by using a computer numerical control (CNC) arm, a robotic arm, or a pulley. . . . In other embodiments, an inlet may be added to connect the chamber to environmental conditions. The inlet may be in an open or closed position.

In block 110, the method 100 may include increasing a first pressure within the air-tight chamber to a second pressure. The first pressure may be approximately atmospheric pressure. The second pressure may be approximately 80 PSI-180 PSI (e.g., approximately 90 PSI-170 PSI, approximately 100 PSI-150 PSI, approximately 110 PSI-125 PSI). In some embodiments, the second pressure may be approximately 100 PSI-160 PSI (e.g., approximately 110 PSI-150 PSI, approximately 125 PSI-135 PSI, approximately 130 PSI-132 PSI). In some embodiments the second pressure may be approximately 130 PSI.

In some embodiments, the first pressure within the air-tight chamber is increased to the second pressure by adjusting a piston or actuator adjustable connected to the die. For example, a piston just within a cavity of the die may move along an axis (e.g., a vertical axis) further into the die (e.g., downward) decreasing the volume within the cavity thereby increasing the pressure within the cavity and the pressure exerted upon the material or sealed particles, as particularly shown in FIG. 2 at steps B-D (piston, 212).

In some embodiments, the first pressure within the air-tight chamber is increased by feeding a gas (e.g., air, nitrogen, nitrogen mixture, or other inert gas) into the air-tight chamber.

In some embodiments, the method 100 may also include heating the air-tight chamber to approximately 50° C. to 300° C. (e.g., approximately 50° C., 55° C., 60° C., 65° C., 70° C., 75° C., 80° C., 85° C., 90° C., 95° C., 100° C., 105° C., 110° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., 300° C.). Heating may occur before increasing the first pressure within the air-tight chamber to the second pressure, simultaneously with increasing the first pressure within the air-tight chamber to the second pressure, or both. Method 100 may include heating the air-tight chamber via conduction, convection, and/or radiation and may include one or more heating elements.

In block 112, the method 100 may include changing the second pressure within the air-tight chamber (e.g., by opening a value that is connected to the air-tight chamber) to a third pressure to create a molded product or a foam from the material in a shape of the die. The third pressure may be approximately atmospheric pressure. In some embodiments, changing the second pressure may include reducing the second pressure to the third pressure. In some embodiments, the change from the second pressure to the third pressure may be controlled, rapid, or may include a pattern (e.g., reducing rapidly, followed by a slow or stopped period of pressure reduction, followed by another rapid reduction in pressure). In some embodiments, the mold position may be changed after expansion.

In some embodiments, the method 100 may include actively ejecting the foam from the die with a piston (opposite the optional piston used to increase the pressure withing the air-tight chamber) that pushes the expanded foam out of the air-tight chamber.

In some embodiments, a release additive may be added to the mixture of the starch powder and water to discourage adhesion of the expanded foam to the air-tight chamber of the die. In some embodiments, a film or coating may be applied to the air-tight chamber of the die.

FIG. 2 shows a schematic of the starch slurry 201 being molded into a molded product 210 in the die 200. As discussed above, the starch slurry 201 is first placed in the die 200 (Step A). The upper portion 204, including the piston 212, of the die 200 can then be gradually pushed downward to enclose the die (Step B) and to increase the pressure in the die (Step C). The pressures within the die can then be adjusted (Step D), as discussed above, and the upper portion 204 removed thereby releasing the molded product 210 that is now in the shape of the die (Step E).

FIG. 3 shows a similar yet varied embodiment of FIG. 2. In Step 1, the particulate or slurry 201 is placed inside the lower portion 202 of the die 300. The die 300 may include a die cavity 202a, an air supply side 304, and a vacuum side 306. In Step 2, air may be provided through the supply side 304 and out of the vacuum side 306 as the upper portion 204 is closed to compress the slurry (Step 3), thereby creating an air-tight chamber. The die 300 may also include one or more micro holes 302 to enable the air to be released from within the inner chamber of the die. In some embodiments, water is used as a binder.

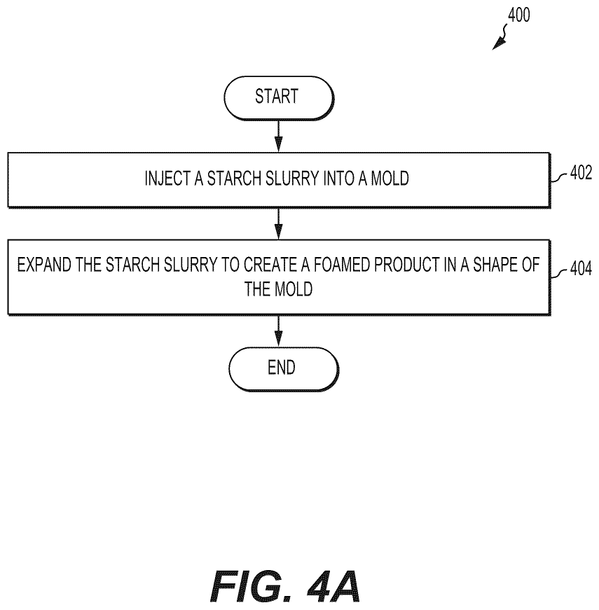

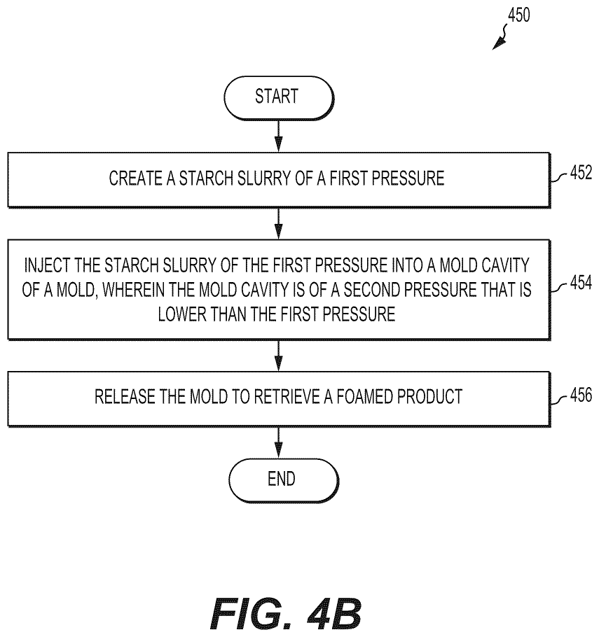

FIG. 4A is a flowchart of a method 400 for making a foamed product.

In block 402, the method may include injecting a starch slurry into a mold. The starch slurry may be any of the starch slurries disclosed herein. An injection pressure of between approximately 1,000 to 35,000 PSI can be used. For example, the pressure range may be between approximately 5,000 to 25,000 PSI, 10,000 to 20,000 PSI, 15000 to 17,000 PSI. The mold may be of any shape and/or dimension appropriate for the specific application. In some embodiments, the mold is temperature controlled.

In block 404, the method may include expanding the starch slurry to create a foamed product in the shape of the mold. The starch slurry may be expanded using microwave, radiofrequency (RF) energy, heat, and/or CO2 expansion. In some embodiments, the resulting foamed product may have a bulk density of approximately 20 pounds per cubic foot (lbs./ft³) or less, for example approximately 20 lbs./ft³, 19.5 lbs./ft³, 19 lbs./ft³, 18.5 lbs./ft³, 18 lbs./ft³, 17.5 lbs./ft³, 17 lbs./ft³, 16.5 lbs./ft³, 16 lbs./ft³, 15.5 lbs./ft³, 15 lbs./ft³, 14.5 lbs./ft³, 14 lbs./ft³, 13.5 lbs./ft³, 13 lbs./ft³, 12.5 lbs./ft³, 12 lbs./ft³, 11.5 lbs./ft³, 11 lbs./ft³, 10.5 lbs./ft³, 10 lbs./ft³, 9.5 lbs./ft³, 9 lbs./ft³, 8.5 lbs./ft³, 8 lbs./ft³, 7.5 lbs./ft³, 7 lbs./ft³, 6.5 lbs./ft³, 6 lbs./ft³, 5.5 lbs./ft³, 5 lbs./ft³, 4.5 lbs./ft³, 4 lbs./ft³, 3.5 lbs./ft³, 3 lbs./ft³, 2.5 lbs./ft³, 2 lbs./ft³, 1.5 lbs./ft³, 1 lbs./ft³, 0.5 lbs./ft³.

The above-described bulk density of the disclosed resulting foam provides an important, critical, and unexpected result in foam formation using the disclosed starch slurries. The bulk densities found in the present invention (e.g., approximately 20 lbs./ft³ or less) provide for a bulk density range that aids in foam expansion as the foam can expand more given there is less material to resist expansion. As the bulk density of the foam increases above 20 lbs./ft³, there is an increased chance of resistance to expansion given the increased amount of material present, the resulting parts may not be lightweight enough for applicable end applications given poor foam expansion, and the resulting products may not be cost-competitive in the relevant markets (e.g., insulated plastics and other alternative materials).

FIG. 4B is a flowchart of a method 450 for making a foamed product.

In block 452, the method may include creating a starch slurry of a first pressure. The starch slurry may include any of the ingredients described herein.

In block 454, the method may include injecting the starch slurry of the first pressure into a mold cavity of a mold, such as cavity 202a of die 300. The mold cavity may be at a second pressure that is lower than the first pressure. In some embodiments, the mold may be heated. The method may include transforming the slurry into a foam prior to introducing the foam into the mold such that the foam may conform to the shape of the mold. In some embodiments, the method may include changing the shape and/or volume of the mold during processing to form the foam. In some embodiments, the method may include inducing a pressure change in the foam or slurry. In some embodiments, the method may include manipulating the atmosphere within the mold via the introduction of a gas or presence of a vacuum.

In block 456, the method may include releasing the mold to retrieve a foamed product. The bulk density of the resulting foamed product may be any of the bulk densities described above with respect to FIG. 4A.

In some embodiments, the methods 100 (FIG. 1), 400 (FIG. 4A), or 450 (FIG. 4B) may include a mold with moveable components such that the shape and volume of the mold cavity may be changed during or after the introduction of the slurry. The change in volume may be controlled so as to generate a controlled change in chamber pressure to precipitate the nucleation of bubbles in the slurry. The change in volume may also be controlled so as to control the density and/or microstructure of the final foamed part. In some embodiments, the mold may be heated to aid with expansion. In some embodiments, the starch slurry may be introduced into the mold in more than one location.

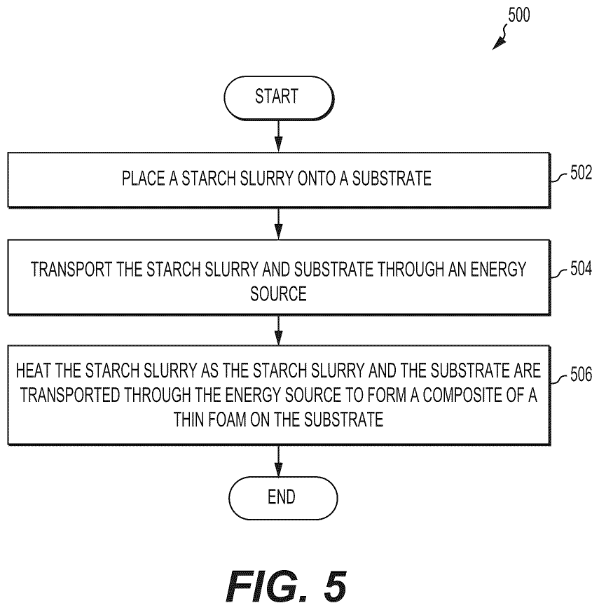

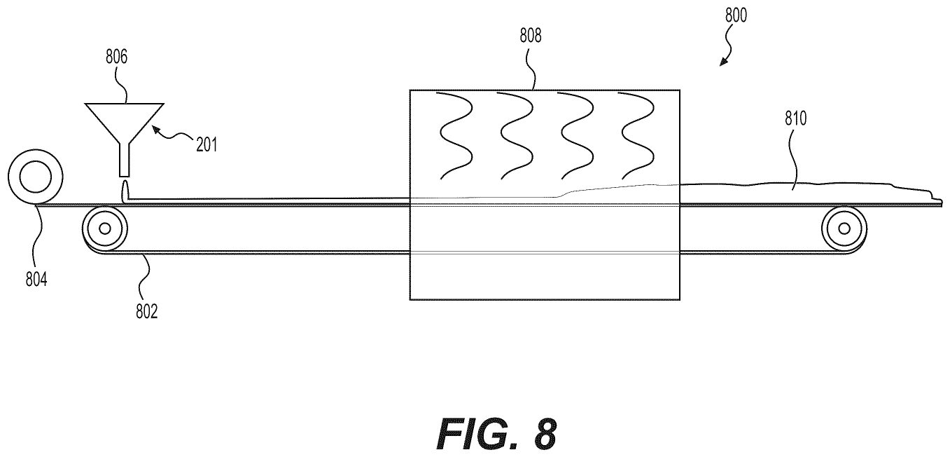

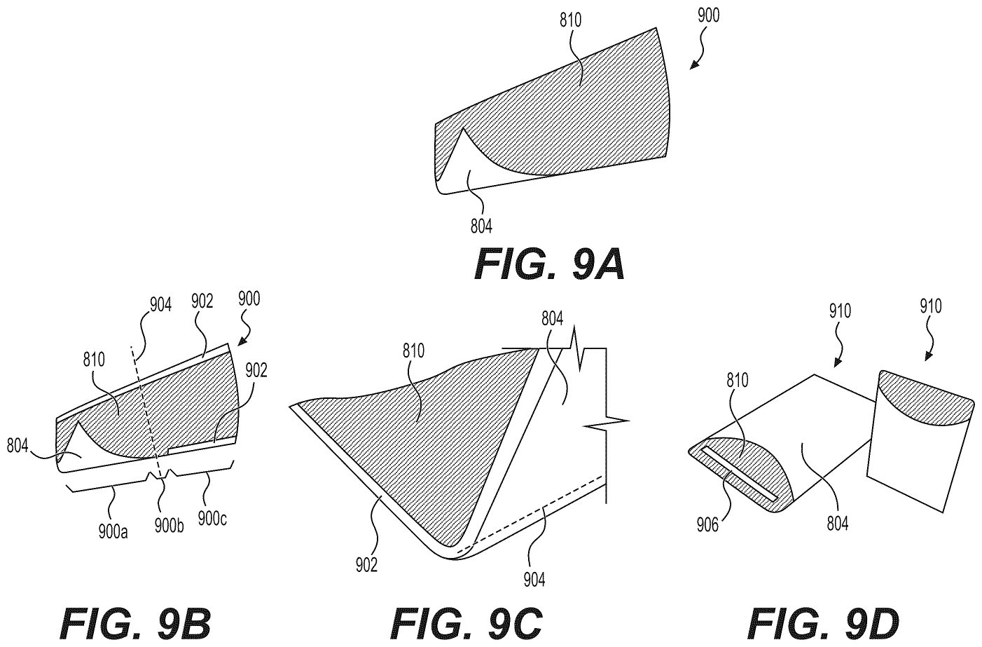

FIG. 5 is a flowchart of a method 500 for making an insulation part. FIGS. 8 and 9A-9D provide a diagram of an exemplary system for making an insulation part (FIG. 8) and a resulting insulation part (FIG. 9A) and insulated product (FIGS. 9B-9D) and will therefore be discussed simultaneously.

In block 502, the method may include placing a starch slurry onto a substrate. In some embodiments, the substrate may be paper or a film, which may be rolled onto a moving component, such as a conveyor belt. In some embodiments, a separate moving component, e.g., conveyor belt, is not needed as the substrate itself may serve as the moving component that transports and adheres to the material. The starch slurry may be any of the starch slurries disclosed herein. One example of this step is illustrated in FIG. 8 where the material (e.g., starch slurry 201) is provided to a hopper 806 for loading onto the substrate 804. The separate moving component 802 is wrapped around at least two wheels, which along with a motor (not shown) and controller (not shown) controls the variable speed at which the substrate and material move.

In block 504, the method may include transporting the starch slurry and substrate through an energy source (e.g., a heater). The moving component may move at a set rate or a dynamic rate that changes based on how much heat or energy is supplied to the starch material. For example, as shown in FIG. 8, the substrate 804 with starch slurry 201 thereon can be moved through an energy source 808. In some embodiments, the starch slurry forms a continuous layer. In other embodiments, the starch slurry is not a continuous layer. In some embodiments, a second substrate may be added that contacts the starch slurry.

In some embodiments, if the slurry is pressurized prior to it being placed onto the substrate, block 504 may be optional. In other embodiments, a second substrate layer may be added to contact with the starch slurry.

In block 506, the method may include heating the starch slurry as the starch slurry and the substrate are transported through the energy source to form a composite of a thin foam on the substrate. Blocks 504 and 506 may occur simultaneously or mostly simultaneously. The energy source may be an oven set to 100° C. to 500° C. (e.g., 100° C., 150° C., 200° C., 250° C., 300° C., 350° C., 400° C., 450° C., 500° C.). Thus, method 500 may include heating the material via an oven. Other heating methods such as use of radiation, convection, radio frequency (RF), and conduction are envisioned. The oven may be set to about 1° C. to about 1000° C. such as about 1° C. to about 25° C., about 25° C. to about 50° C., about 50° C. to about 75° C., about 75° C. to about 100° C., about 100° C. to about 125° C., about 125° C. to about 150° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 500° C. to about 525° C., about 525° C. to about 550° C., about 550° C. to about 575° C., about 575° C. to about 600° C., about 600° C. to about 625° C., about 625° C. to about 650° C., about 650° C. to about 675° C., about 675° C. to about 700° C., about 700° C. to about 725° C., about 725° C. to about 750° C., about 750° C. to about 775° C., about 775° C. to about 800° C., about 800° C. to about 825° C., about 825° C. to about 850° C., about 850° C. to about 875° C., about 875° C. to about 900° C., about 900° C. to about 925° C., about 925° C. to about 950° C., about 950° C. to about 975° C., about 975° C. to about 1000° C.

In some embodiments, the method 500 may include rolling the composite foam material onto a core to produce rolled stock.

In some embodiments, the method 500 may include creating a negative pressure environment (e.g., creating a vacuum that is less than 1 atm) inside the energy source to reduce the amount of heat or energy required by the energy source to form the thin foam from the material.

As shown in FIG. 8, the material can be placed on an unrolled substrate 804 (e.g., paper) on a moving component 802 which moves the material and the substrate through an oven 808. In other embodiments, the material and the substrate may move via the moving component through an energy source that emits waves of energy (e.g., microwaves or radio frequency) that excite and heat the material to promote expansion. In one embodiment, the energy source is a microwave tube.

In some embodiments the slurry may be heated entirely or in part via microwave or radio frequency (RF) energy. In some embodiments, the distribution of the RF energy may be designed such that the material is heated evenly. In some embodiments, the RF energy may be distributed in such a way as to cause varying degrees of heating and/or expansion at specific points across a substrate or within a layer of slurry. The distribution of the RF energy may change according to the design of the part being manufactured and/or may be controlled via mechanical or electrical means or a combination of the two, e.g., a phased array of RF sources, manipulation of the shape of the chamber, and/or movement and/or location of antenna or waveguide elements. Turning back to FIG. 8, once the starch slurry 201 and substrate 804 move through the energy source 808, the starch slurry 201 expands to thereby form a composite of a thin foam 810 on the substrate 804. In some embodiments, the method 500 may include cutting the composite in a transverse direction to a moving direction of the moving component forming one or more approximately rectangular-shaped insulation parts (FIG. 9A). In some embodiments, the method may include cutting the composite in the machine direction. In some embodiments, the method may include cutting the composite in angular, curved, wavey, or other ways with respect to the moving direction of the moving component. In some embodiments, the composite may have creases in the cross or machine direction, or any direction. In some embodiments, the creases are performed using heat.

FIG. 9A shows an example resulting insulation part 900 that includes the substrate 804 with the thin foam 810 disposed thereon. Such an insulation part 900 can be used to form a variety of insulation products, such as insulation panels, mailers, insulated containers, insulated sleeves, etc. For example, FIGS. 9B-9D show steps for forming the insulation part 900 into an insulated product 910 (e.g., a mailer). In FIG. 9B, water or some type of adhesive can be applied to one or more edges 902 (e.g., parallel edges) of the insulated part 900. The insulation part 900 can then be folded (e.g., in half) along line 904 (FIGS. 9B-9C), and the wetted edges pressed or sealed together (e.g., applying pressure, heat, or both) to form the mailer 910 (FIG. 9D). In some embodiments, edges 902 are not covered with foam. In some embodiments, an adhesive strip can be placed on a surface of the substrate 804 and/or the thin foam 810 (e.g., adhesive strip 906, FIG. 9D) and configured to attach to another surface of another substrate and/or thin foam. In some embodiments, the substrate can be coated or laminated.

In some embodiments, a barrier can be placed on the thin foam but before the insulation parts are folded. Additional water may be applied in spots to the foam so that the barrier adheres to the foam and stays in place. This barrier may be paper or film. In some embodiments, the paper may be coated with a petroleum or non-petroleum coating. In some embodiments, the coating is heat-sealable, and/or water-resistant, and/or curbside recyclable, and/or compostable. The barrier prevents the internal foam from touching, interfering, or reacting with an item placed in the completed insulated mailer 910.

In some embodiments, the barrier is narrower in width than a width of the one or more approximately rectangular shaped-insulation parts.

In some embodiments, the composite may be cut and folded to create one or more insulated inserts to line a box.

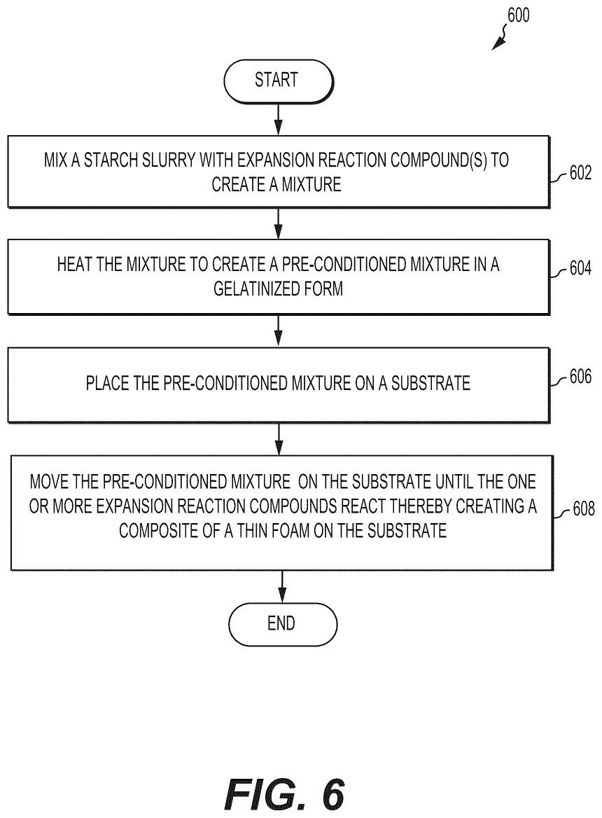

FIG. 6 is a flowchart of a method 600 for making an insulation part.

In block 602, the method may include mixing a starch slurry (e.g., starch slurry 201) with one or more expansion reaction compounds to create a mixture. As disclosed herein, the expansion reaction compound(s) may include sodium bicarbonate and vinegar, which form carbon dioxide almost immediately thereby creating foam, and/or may include sodium bicarbonate and a dry acid (e.g., baking powder). Alternatively, yeast may be added to convert internal carbohydrates into carbon dioxide.

In block 604, the method may include heating the mixture to create a pre-conditioned mixture in a gelatinized form. This step may be the same as or similar to block 104 of method 100.

In block 606, the method may include placing the pre-conditioned mixture on a substrate on a moving component (e.g., a conveyor belt). This step may be the same as or similar to block 502 of method 500.

In block 608, the method may include moving the moving component to transport the pre-conditioned mixture on the substrate until the one or more expansion reaction compounds react thereby creating a composite of a thin foam on the substrate. In this step, instead of using an energy source (e.g., a heater), the mixture, given its inclusion of the one or more expansion reaction compounds, may immediately (e.g., using sodium bicarbonate and vinegar as the one or more expansion reaction compounds) or in a delayed fashion (e.g., using sodium bicarbonate and a dry acid) expand to create a composite of a thin foam adhered to the substrate, such as shown in and described above with respect to FIG. 9A.

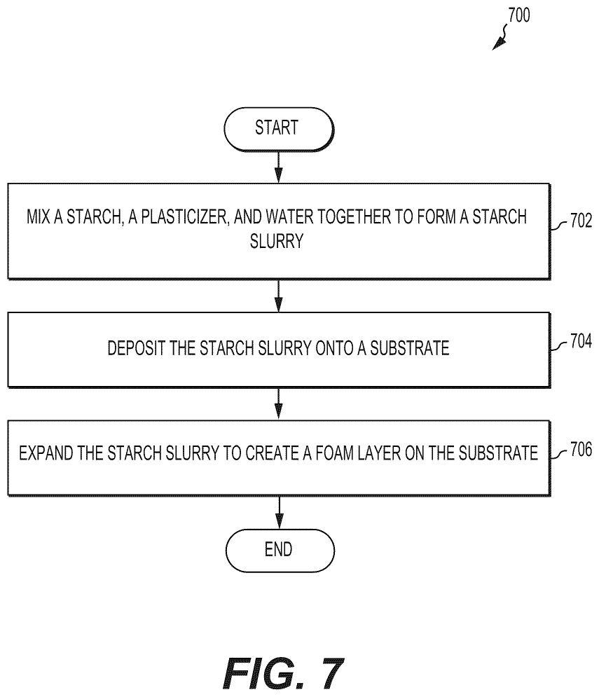

FIG. 7 is a flowchart of a method 700 for making an insulation part.

In block 702, the method may include mixing at least a starch, a plasticizer, and water together to form a starch slurry. This step may be the same as or similar to block 102 of method 100. In some embodiments, this step may include mixing one or more expansion reaction compounds into the starch slurry to provide a varied method for expanding the slurry, as discussed herein.

In block 704, the method may include depositing the starch slurry onto a substrate. This step may be the same as or similar to block 502 of method 500. In some embodiments, the starch slurry can be deposited onto an entire surface of the substrate, or deposited only in certain locations (e.g., spaced apart locations) on the substrate.

In block 706, the method may include expanding the starch slurry to create a foam layer on the substrate. The foam layer may be continuous or discontinuous. Such expansion of the starch slurry can be conducted using any of the methods discussed herein.

In some embodiments, a first amount of the starch slurry may be continuously deposited onto a first portion of the substrate. The first amount of the starch slurry may be expanded to create a first section of thin foam having a first average thickness. A second amount of starch slurry can then be expanded to create a second section having a second average thickness that is less than the first average thickness. A third amount of starch slurry can be expanded to create a third section having a third average thickness that is greater than the second average thickness. For example, as shown in FIG. 9B, the second section 900b of the insulated part 900 may be configured to have a lower average thickness compared to the first section 900a and/or third section 900c. An advantage of such configuration may be that it aids in more easily folding or handling the insulated part 900 to form the resulting insulated product 910. The first, second, and third average thicknesses can range between approximately 0.125 inches to 2.0 inches, such as between approximately 0.125 inches to 0.75 inches. The first, second, and/or third sections may include one or more layers of slurry.

In some embodiments, a second substrate (e.g., paper) can be disposed over the expanded thin foam and attached to the first substrate and/or foam to create a foam-lined product. The foam-lined product can be folded along a line across the second section, as discussed above with respect to FIGS. 9B-9C.

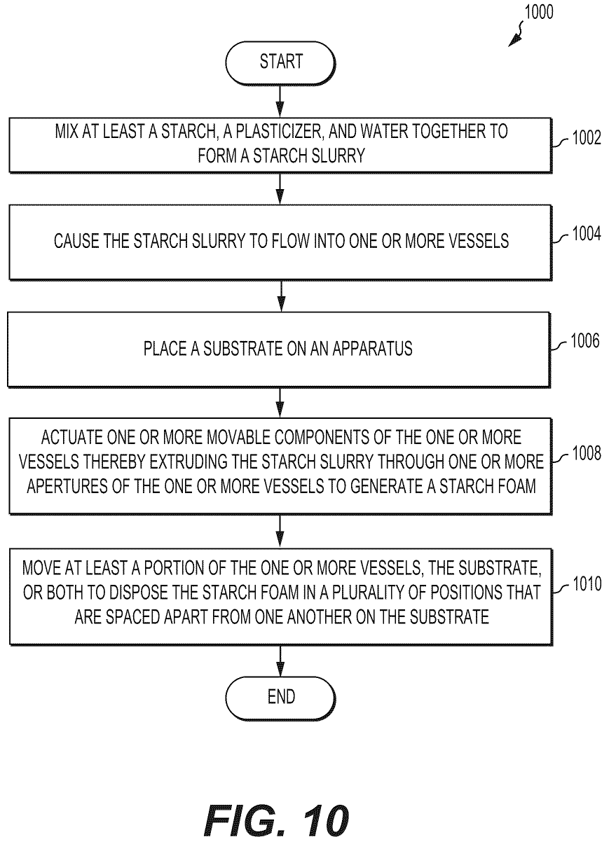

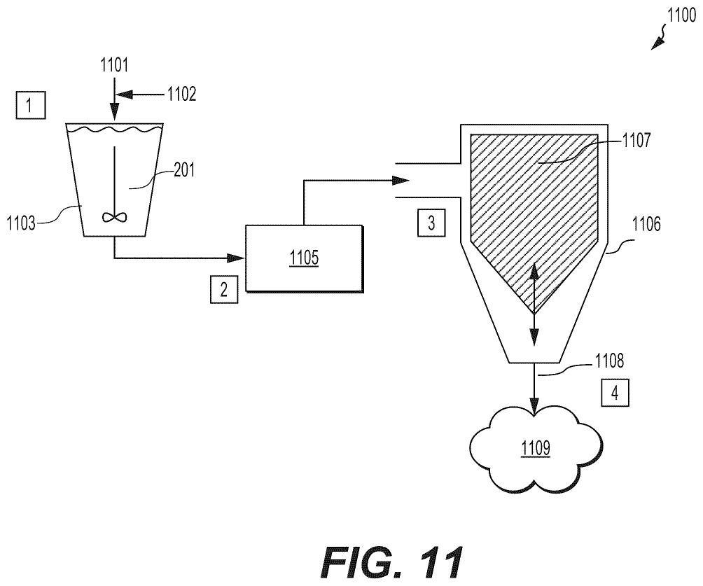

FIG. 10 is a flowchart of a method 1000 for making an insulation panel by depositing a starch foam. FIGS. 11-13 provide diagrams of an exemplary system and associated components for printing a starch foam and will therefore be discussed simultaneously.

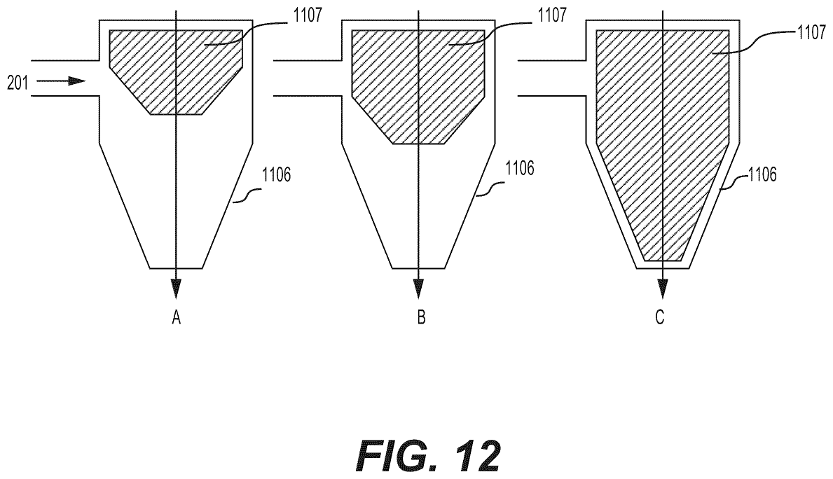

In block 1002, the method may include mixing at least a starch, plasticizer, and/or water together to form a starch slurry. As shown in Step 1 of FIG. 12, at least starch 1101 and water 1102 may be mixed in the mixing vessel 1103 to generate the starch slurry 201. As discussed herein, one or more additional components (e.g., a plasticizer) may be mixed into the slurry as well. In some embodiments, the starch slurry may be preconditioned to a desired temperature (e.g., below approximately 200 degrees Fahrenheit (° F.), or between approximately 50 to 150 degrees ° F., between approximately 75 to 100 degrees ° F., between approximately 85 to 95 degrees° F.).

In block 1004, the method may include causing the starch slurry to flow into one or more vessels (e.g., a printing vessel(s)). As shown in Step 2 of FIG. 12, this step may be conducted via pressurization using a pressure intensifier mechanism and/or a pump, e.g., pump 1105. In some embodiments, the utilized pressure may be between approximately 760 mmHg and approximately 2,000,000 mmHg (e.g., between approximately 1,000 mmHg and 1,250,000 mmHg, between approximately 3,000 mmHg and 100,000 mmHg, between approximately 50,000 mmHg and 80,000 mmHg). In some embodiments, the system 1100 may be configured to automatically mix and/or pressurize the starch slurry based on received user input information (e.g., from a control interface or PLC program) to arrive at a target size and/or target density for a resulting insulation part or insulated product, as discussed herein. In some embodiments, the process may be conducted without pressuring the starch slurry, but instead by causing the starch slurry to flow into the printing vessel using some other means, such as gravity.

In some embodiments, heat can be introduced gradually throughout the transport piping to improve flow dynamics and to gradually introduce energy to the slurry, yet controlling the timing of reaction events, e.g., the crystallization of starch or activation of a gas generating reaction, by maintaining pre-defined temperature ranges. For example, the slurry can be heated to between approximately 35 degrees Celsius (° C.) and 300 degrees° C. (e.g., between approximately 45° C. to 250° C., between approximately 75° C. to 210° C., between approximately 100° C. to 175° C., between approximately 125° C. to 150° C.).

In some embodiments, the energy of the starch slurry may be increased prior to release. The increase in energy may be thermal via an elevated temperature, and/or chemical via a solution or reaction equilibrium, and/or mechanical via pressure. Energy may also be generated within the slurry via activity of a biological precursor consuming an element of the slurry to generate heat, change a chemical equilibrium, or generate gas. The energy source(s) may be introduced into the starch slurry at one or more steps throughout the printing process, such as before the starch slurry flows into the vessel(s) (e.g., printing vessel(s)), or before the vessel mechanism (nozzle) are actuated, as further discussed below. In some embodiments, an external blowing agent in liquid or gas form is introduced to aid in forming the starch foam from the starch slurry. In other embodiments, an external agent (e.g., vinegar) may be added to chemically react with the starch slurry and to generate gas as a byproduct to promote expansion.

In some embodiments, in increasing the energy source(s) into the starch slurry, one or more reactions, processes, and/or phase changes may occur throughout the starch slurry thereby nucleating gas-filled bubbles dispersed throughout the starch slurry.

In some embodiments, the starch slurry (either pressurized or non-pressurized) may be directed through a molding process. For example, the starch slurry may be directed into molds having one or more shapes and/or sizes such that the generated starch foam (discussed further below) may expand into certain predefined shapes and/or sizes.

In block 1006, the method may include placing a substrate on an apparatus. For example, as discussed herein, the substrate may be placed on an apparatus configured for movement (e.g., a conveyor belt, a nip roll, etc.). The substrate may be a cellulose-based single sheet made of, for example, paper, cardboard, etc. The substrate may be the first or bottom layer of a later-formed insulation panel, as further discussed herein. In some embodiments, the substrate is kraft paper or linerboard. In other embodiments, the substrate is virgin and/or recycled kraft paper. In some embodiments, the substrate is Machine Glazed (MG), Machine Finished (MF). In other embodiments, the substrate has a coating on its one or two faces. In some embodiments, the coating is hydrophobic, such as a wax or petroleum-derived coating, such as polyethylene. In other embodiments, the paper is compostable and/or recyclable.

In block 1008, the method may include actuating one or more movable components of the one or more vessels thereby extruding the starch slurry through one or more apertures of the vessel(s) to generate a starch foam. The method may also include positioning one or more movable components (e.g., plunger(s), nozzle plunger(s), rotating auger(s)) of the one or more vessels in a first position to enable the starch slurry to fill a respective body of the one or more vessels. As shown in Step 3 of FIG. 11, a vessel body 1106 having a movable component 1107 therein (e.g., a plunger) may be utilized. As particularly shown in FIG. 12, the movable component 1107 may have at least three different positions (e.g., A, B, C) in which it can be placed within the vessel body 1106 to conduct various actions with respect to the starch slurry 201. The first position “A” may be an “open” position in which the movable component 1107 is raised to the top portion of the vessel body 1106 such that the starch slurry 201 can fill the vessel body 1106.

In some embodiments, the one or more movable components may not be needed if the vessel is sufficiently pressurized to cause the slurry to be extruded from the vessel(s), as further discussed below.

In some embodiments, the method may include positioning the movable component(s) in a second position to prevent further flow of the starch slurry. That is, once the starch slurry fills the respective nozzle body of the printing vessel(s) to the desired amount, the nozzle plunger(s) may be changed to a “closed” position, as shown as second position “B” in FIG. 12, to prevent any further flow.

The method may include actuating the movable component(s) of the printing vessel(s) thereby extruding the starch slurry through one or more apertures of the vessel(s) to generate the starch foam. In some embodiments, the aperture(s) is between approximately 0.001 inches to approximately 0.20 inches. In other embodiments, the aperture is between approximately 0.020 inches to approximately 10.00 inches. The aperture can be spherical, elliptical, polygonal, annular or other geometry/shapes known in the art of extrusion. In some embodiments, the aperture is “hollow,” e.g., the aperture has a solid core and an open area at its periphery. In other embodiments, the aperture has a self-cleaning mechanism to prevent clogging.

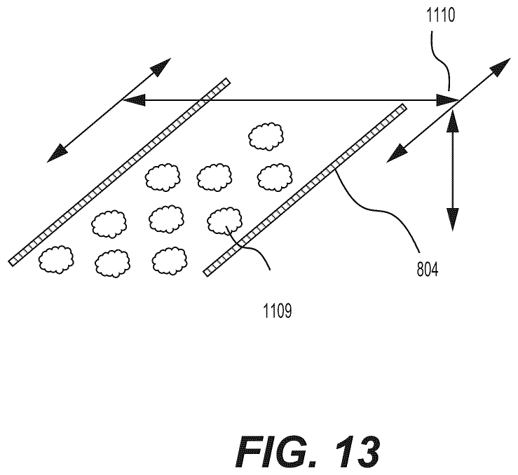

As shown in FIG. 12, actuating the movable component(s) 1107 may include engaging the movable component(s) or placing the movable component(s) in a third position “C” thereby compressing the starch slurry. Turning back to Step 4 of FIG. 11, the starch slurry can then be extruded through the aperture(s) 1108 of the vessel(s) which may cause the starch slurry to reach approximately ambient and standard pressure and temperature, thereby causing the water in the slurry to evaporate or boil and the starch slurry to expand, creating the starch foam 1109. In such embodiments where the slurry is not pressurized, as discussed above, the starch slurry may expand via one or more other methods, such as heat, and/or microwaves, and/or time, and/or intrinsic gas nucleation/generation, etc. As shown in FIG. 13, the starch foam may be printed onto a substrate 804 (e.g., a paper sheet or barrier) in a specific pattern. In some embodiments, the method may include forming the starch foam into one or more predetermined shapes.

The resulting starch foam of the above-described printing process may be of a size and/or density controlled by one or more operating parameters of the vessel(s) and/or the specific chemical formulation of the starch foam. The operating parameters may include, for example, the pressure exerted by the movable component(s) (e.g., between approximately 760 mmHg and approximately 2,000,000 mmHg, between approximately 1,000 mmHg and 1,250,000 mmHg, between approximately 3,000 mmHg and 100,000 mmHg, between approximately 50,000 mmHg and 80,000 mmHg), an activation speed of the movable component(s), thermal energy introduced into the vessel(s) (e.g., a temperature between approximately 35 to 300 degrees ° C.), and/or gas introduced into the vessel(s).

In block 1010, the method may include moving at least a portion of the vessel(s), the substrate, or both to dispose the starch foam in a plurality of positions that are spaced apart from one another on the substrate. In some embodiments, starch foam is enclosed within two layers of substrate on all sides to create foamed “cells”. As shown in FIG. 13, the starch foam 1109 may be extruded or “printed” onto a first or bottom substrate 804. In some embodiments, the movable component(s) 1107 of the vessel(s) 1106 may be controlled, e.g., electronically, pneumatically, or hydraulically. The movable component(s) 1107 and/or the aperture 1108 may be mounted on linear guides, e.g., 3-axis CNC 1110, or a robot arm, located above the substrate 804 such that the starch foam 1109 can be printed in a specific pattern and/or orientation.

In some embodiments, the steps included in the descriptions of blocks 1008 and 1010 may occur simultaneously.

In some examples, disclosed systems or methods may involve one or more of the following clauses:

Clause 1: A starch slurry comprising: a starch in an amount of between approximately 25 to 98 weight percent; a plasticizer in an amount of between approximately 3 to 30 weight percent; water in an amount of between approximately 5 to 60 weight percent; and one or more agents in an amount of between approximately 1 to 10 weight percent, wherein a bulk density of the starch slurry is between approximately 10 to 100 pounds per cubic foot.

Clause 2: The starch slurry of clause 1, wherein the one or more agents comprise one or more of a surfactant, a nucleating agent, a foaming agent, a rheology modifier, a colorant, a foam stabilizing agent, a leavening agent, or combinations thereof.

Clause 3: The starch slurry of any of clauses 1-2, wherein the one or more agents comprise between approximately 3 to 7 weight percent of the starch slurry.

Clause 4: A starch slurry comprising: a starch in an amount of between approximately 25 to 98 weight percent; a plasticizer in an amount of between approximately 3 to 30 weight percent; and water in an amount of between approximately 5 to 60 weight percent, wherein a bulk density of the starch slurry is between approximately 20 to 80 pounds per cubic foot.

Clause 5: The starch slurry of clause 4, wherein the starch slurry comprises one or more of a dent starch, a chemically modified starch, a sugar, high amylose corn starch, or combinations thereof.

Clause 6: The starch slurry of any of clauses 4-5, wherein the starch comprises between approximately 25 to 50 weight percent of the starch slurry.

Clause 7: The starch slurry of any of clauses 4-6, wherein the water comprises between approximately 5 to 9 weight percent of the starch slurry.

Clause 8: The starch slurry of any of clauses 4-7, wherein the plasticizer comprises polyvinyl alcohol (PVOH).

Clause 9: The starch slurry of any of clauses 4-7, wherein the plasticizer comprises poly (butylene adipate-co-terephthalate) (PBAT).

Clause 10: The starch slurry of any of clauses 4-7, wherein the plasticizer comprises polyvinyl acetate (PV A).

Clause 11: The starch slurry of any of clauses 4-7, wherein the plasticizer comprises polylactic acid (PLA).

Clause 12: The starch slurry of any of clauses 4-7, wherein the plasticizer comprises polyhydroxyalkanoate (PHA).

Clause 13: The starch slurry of any of clauses 4-7, wherein the plasticizer comprises glycerol.

Clause 14: The starch slurry of any of clauses 4-13, wherein the starch slurry consists essentially of the starch, the plasticizer, and water.

Clause 15: The starch slurry of any of clauses 4-14, wherein the starch slurry is substantially free of a blowing agent.

Clause 16: The starch slurry of any of clauses 4-13, wherein the starch slurry further comprises a blowing agent, and wherein the blowing agent comprises an acrylonitrile copolymer, a vinyl copolymer, or both.

Clause 17: The starch slurry of any of clauses 4-13 and 16, wherein the starch slurry further comprises one or more a leavening agent, a coloring agent, a nucleation agent, a blowing agent, a stabilizing agent, a rheology agent, cellulose, or a combination thereof.

Clause 18: The starch slurry of clause 17, wherein the starch slurry further comprises: the leavening agent comprising one or more of yeast, sodium bicarbonate, baking soda, baking powder, or a combination thereof; the coloring agent comprising lignin, a food grade die, or both; the nucleation agent comprising calcium carbonate (CaCO₃), talc, or both; the blowing agent comprising one or more of a thermoplastic microsphere, an acrylonitrile copolymer, a vinyl copolymer, or combinations thereof; the stabilizing agent comprising lecithin, protein, or both; and the rheology agent comprising one or more of carboxymethyl cellulose (CMC), hydroxypropyl cellulose (HPMC), methylcellulose (MC), xanthan gum, guar gum, carrageenan, or combinations thereof.

Clause 19: The starch slurry of any of clauses 17-18, wherein: the leavening agent comprises between approximately 0.1 to 35 weight percent of the starch slurry; the coloring agent comprises between approximately 0.1 to 5 weight percent of the starch slurry; the nucleation agent comprises between approximately 0.1 to 5 weight percent of the starch slurry; the blowing agent comprises between approximately 0.1 to 8 weight percent of the starch slurry; the stabilizing agent comprises between approximately 0.1 to 15 weight percent of the starch slurry; the rheology agent comprises between approximately 0.1 to 5 weight percent of the starch slurry; and the cellulose comprises less than approximately 60 weight percent of the starch slurry.

Clause 20: A method for molding an insulation part using the starch slurry of clause 4, the method comprising: placing a starch slurry into a die; closing the die to form an air-tight chamber within the die, the air-tight chamber comprising the starch slurry; increasing a first pressure within the air-tight chamber to a second pressure; and die changing the second pressure within the air-tight chamber to a third pressure to create a molded product from the starch slurry, the molded product being in a shape of the die.

Clause 21: A method for making a foamed product using the starch slurry of any of clauses 4-19, the method comprising: creating a starch slurry of a first pressure; injecting the starch slurry of the first pressure into a mold cavity of a mold, wherein the mold cavity is of a second pressure that is lower than the first pressure; and releasing the mold to retrieve a foamed product, wherein the foamed product has a bulk density of approximately 20 pounds per cubic foot or less.

Clause 22: A method for making a foamed product using the starch slurry of any of clauses 4-19, the method comprising: injecting a starch slurry into a mold; and expanding the starch slurry to create a foamed product in a shape of the mold, wherein expanding the starch slurry is conducted using one or more of microwave, radiofrequency (RF) energy, heat, CO2 expansion, or a combination thereof; and wherein the foamed product has a bulk density of approximately 20 pounds per cubic foot or less.

Clause 23: A method for making an insulation part from the starch slurry of any of clauses 4-19, the method comprising: placing a starch slurry onto a substrate; transporting the starch slurry and substrate through an energy source; and heating the starch slurry as the starch slurry and the substrate are transported through the energy source to form a composite of a thin foam on the substrate.

Clause 24: A method for making an insulation part from the starch slurry of any of clauses 4-19, the method comprising: mixing a starch slurry with one or more expansion reaction compounds to create a mixture; heating the mixture to create a pre-conditioned mixture in a gelatinized form; placing the pre-conditioned mixture on a substrate; and moving the pre-conditioned mixture on the substrate until the one or more expansion reaction compounds react thereby creating a composite of a thin foam on the substrate.

Clause 25: A method of making an insulation panel from the starch slurry of any of clauses 4-19, the method comprising: causing a starch slurry to flow into a vessel; placing a substrate on an apparatus; and simultaneously, to generate the insulation panel: moving the apparatus to transport the substrate; and actuating a movable component of the vessel thereby extruding the starch slurry through an aperture of the vessel to deposit one or more starch foam units onto the substrate in each of two or more first locations spaced apart from one another.

Clause 26: A method of making an insulation part, the method comprising: mixing a starch, a plasticizer, and water together to form a starch slurry; depositing the starch slurry onto a substrate; and expanding the starch slurry to create a foam layer on the substrate.

Clause 27: The method of clause 26, further comprising mixing one or more expansion reaction compounds into the starch slurry, wherein expanding the starch slurry comprises reacting the one or more expansion reaction compounds using one or more of microwave, radiofrequency (RF) energy, heat, CO₂ expansion, or a combination thereof.

Clause 28: The method of any of clauses 26-27, wherein the starch slurry is deposited on an entire surface of the substrate.

Clause 29: A method of depositing a starch foam, the method comprising: mixing at least a starch, a plasticizer, and water together to form a starch slurry; causing the starch slurry to flow into one or more vessels; actuating one or more movable components of the one or more vessels thereby extruding the starch slurry through one or more apertures of the one or more vessels to generate a starch foam; and moving at least a portion of the one or more vessels, a substrate, or both to dispose the starch foam in a plurality of positions that are spaced apart from one another on the substrate.

Clause 30: The method of clause 29, wherein: the starch comprises between approximately 25 to 98 weight percent of the starch slurry; the plasticizer comprises between approximately 3 to 30 weight percent of the starch slurry; the water comprises between approximately 5 to 60 weight percent of the starch slurry; and wherein the starch foam has a bulk density of approximately 20 pounds per cubic foot or less.

Clause 31: The method of clause 20, wherein the first pressure is approximately atmospheric pressure, the second pressure is 80 psi to 180 psi, and the third pressure is approximately atmospheric pressure.

Clause 32: The method of any of clauses 20 and 31, further comprising: heating the air-tight chamber to approximately 120° C. to 180° C.

Clause 33: The method of any of clauses 20 and 31-32, wherein increasing the first pressure within the air-tight chamber comprises adjusting a piston or actuator adjustably connected to the die.

Clause 34: The method of any of clauses 20 and 31-33, further comprising: mixing at least starch powder and water to create a mixture; and heating the mixture to create a pre-conditioned mixture in a gelatinized form, wherein the pre-conditioned mixture is the starch slurry placed into the die.

Clause 35: The method of any of clauses 20 and 31-34, wherein the pre-conditioned mixture is the starch slurry placed into the die.

Clause 36: The method of any of clauses 20, 31-32, and 34-35, wherein increasing the first pressure of the air-tight chamber comprises feeding a gas into the air-tight chamber.

Clause 37: The method of clause 36, further comprising: mixing at least starch powder and water to create a mixture; and heating the mixture to create a pre-conditioned mixture in a gelatinized form, and wherein the pre-conditioned mixture is the starch slurry placed into the die.

Clause 38: The method of any of clauses 36-37, wherein the die comprises six sides with a gas inlet on a first side and a gas outlet on a second side.

Clause 39: The method of clause 38, wherein the first side and the second side are a same side of the six sides of the die.

Clause 40: The method of any of clauses 38-39, wherein the six sides of the die interlock to form the air-tight chamber.

Clause 41: The method of any of clauses 20, and 31-40, wherein the die comprises one or more modular parts configured to occupy volume within the air-tight chamber to generate foam of a desired shape.

Clause 42: The method of clause 23, further comprising creating a negative pressure environment inside the energy source to reduce the amount of heat or energy required by the energy source to form the thin foam from the starch slurry.

Clause 43: The method of any of clauses 23 and 42, further comprising rolling the composite onto a core.

Clause 44: The method of any of clauses 23 and 42-43, further comprising: cutting the composite in a transverse direction to a moving direction of the substrate forming one or more approximately rectangular-shaped insulation parts; applying water to two parallel edges of the one or more approximately rectangular-shaped insulation parts; folding the one or more approximately rectangular-shaped insulation parts in half; and applying pressure, heat, or both to the two parallel edges to bond the two parallel edges to create an insulated product.

Clause 45: The method of clause 44, wherein the insulated product comprises an insulated mailer.

Clause 46: The method of any of clauses 44-45, further comprising: placing a barrier on the thin foam of the one or more approximately rectangular shaped-insulation parts after applying the water to the two parallel edges and before the one or more approximately rectangular-shaped insulation parts are folded.

Clause 47: The method of clause 46, wherein the barrier is narrower in width then than a width of the one or more approximately rectangular shaped-insulation parts.

Clause 48: The method of any of clauses 23 and 42-47, wherein the energy source is an oven set to 120° C. to 180° C.

Clause 49: The method of any of clauses 23 and 42-47, wherein the energy source is a microwave tube.

Clause 50: The method of any of clauses 23 and 42-49, wherein the energy source comprises a wave energy source that heats the starch slurry to form the composite of thin foam on the substrate by energizing a sheet of wave energy over the starch slurry.

Clause 51: The method of any of clauses 23 and 42-50, wherein the energy source comprises: a wave energy source that energizes the starch slurry without promoting the starch slurry to foam by energizing a sheet of wave energy over the starch slurry, and one or more auxiliary beam sources that also energizes one or more portions of the starch slurry energized by the wave energy source such that constructive interference between the wave energy source and the one or more auxiliary beam sources causes the starch slurry to foam and form the composite with the substrate.

Clause 52: The method of clause 51, wherein the one or more auxiliary beam sources are placed to create an uneven thin foam on the substrate.

Clause 53: The method of clause 51, wherein the one or more auxiliary beam sources are placed to create a custom expansion pattern of the thin foam on the substrate.

Clause 54: The method of clause 23, further comprising: mixing at least starch powder and water to create a mixture; and heating the mixture to create a pre-conditioned mixture in a gelatinized form, and wherein the pre-conditioned mixture is the starch slurry placed on the substrate.

Clause 55: The method of clause 54, wherein the starch powder comprises dent starch, waxy starch, high-amylose starch, a chemically substituted starch, or combinations thereof.

Clause 56: The method of clause 23, wherein the substrate is paper.

Clause 57: The method of clause 24, wherein the starch slurry comprises dent starch, waxy starch, high-amylose starch, a chemically substituted starch, or combinations thereof. Clause 58: The method of any of clauses 24 and 57, wherein the substrate is paper.

Clause 59: The method of any of clauses 24 and 57-58, wherein the one or more expansion reaction compounds comprises sodium bicarbonate and vinegar.

Clause 60: The method of any of clauses 24 and 57-58, wherein the one or more expansion reaction compounds comprises sodium bicarbonate and a dry acid.

Clause 61: The method of any of clauses 24 and 57-58, wherein the one or more expansion reaction compounds comprises baking powder.

Clause 62: The method of any of clauses 24 and 57-58, wherein the one or more expansion reaction compounds comprises sodium bicarbonate and a dry acid and the mixture also comprises water.

Clause 63: The method of any of clauses 24 and 57-62, further comprising rolling the composite onto a core.

Clause 64: The method of any of clauses 24 and 57-63, further comprising: cutting the composite in a transverse direction to a moving direction of the substrate forming one or more approximately rectangular-shaped insulation parts; applying water to two parallel edges of the one or more approximately rectangular-shaped insulation parts; folding the one or more approximately rectangular-shaped insulation parts in half; and applying pressure, heat, or both to the two parallel edges to bond the two parallel edges to create an insulated mailer.

Clause 65: The method of clause 29, wherein the starch foam is formed into one or more predetermined shapes.

Clause 66: The method of any of clauses 29 and 65, wherein the starch slurry comprises a homogenous slurry.

Clause 67: The method of any of clauses 29 and 65-66, wherein causing the starch slurry to flow into the one or more vessels comprises pressurizing the starch slurry to a first pressure using a pressure intensifier mechanism, a pump, or both.

Clause 68: The method of clause 67, wherein the first pressure is between approximately 760 mmHg and approximately 50,000 mmHg.

Clause 69: The method of any of clauses 29 and 65-68, further comprising: mixing one or more additives into the starch slurry.

Clause 70: The method of any of clauses 29 and 65-69, further comprising: positioning the one or more movable components in a first position to enable the starch slurry to fill a respective body of the one or more vessels; and after the starch slurry fills the respective body of the one or more vessels, positioning the one or more movable components in a second position to prevent further flow of the starch slurry, wherein actuating the one or more movable components comprises positioning the one or more movable components in a third position thereby compressing and liquifying the starch slurry.

Clause 71: The method of any of clauses 29 and 65-70, wherein extruding the starch slurry through the one or more apertures of the one or more vessels causes the starch slurry to reach approximately ambient and standard pressure and temperature thereby causing the starch slurry to expand.

Clause 72: The method of any of clauses 29 and 65-71, wherein the starch slurry comprises starch powder.

Clause 73: The method of any of clauses 29 and 65-72, wherein causing the starch slurry to flow into the one or more vessels is conducted via pressure, gravity, or both.

Clause 74: The method of any of clauses 29 and 65-73, further comprising: introducing one or more energy sources into the starch slurry prior to actuating the one or more movable components of the one or more vessels.

Clause 75: The method of clause 74, wherein the one or more energy sources comprise one or more of heat, pressure, solution equilibrium, chemical potential energy, a biological precursor, or combinations thereof.

Clause 76: The method of any of clauses 74-75, wherein introducing the one or more energy sources into the starch slurry results in generation of a blowing agent configured to aid in generating the starch foam.

Clause 77: The method of any of clauses 29 and 65-76, wherein the starch foam is generated via one or more actions that occur throughout the starch slurry.

Clause 78: The method of clause 77, wherein the one or more actions comprise one or more of a reaction, a process, a phase change, or combinations thereof.

Clause 79: The method of any of clauses 77-78, wherein the one or more actions result in nucleation of one or more bubbles throughout the starch slurry, the one or more bubbles comprising a gas.

Clause 80: A starch foam produced via the method of any of clauses 29 and 65-79.

Clause 81: The starch foam of clause 80, wherein the starch foam is of a first size and a first density.

Clause 82: The starch foam of clause 81, wherein the first size and the first density are based on one or more operating parameters of the one or more vessels, a chemical formulation of the starch foam, or both.

Clause 83: The starch foam of clause 82, wherein the one or more operating parameters of the one or more vessels comprise one or more of a pressure exerted by the one or more movable components, an activation speed of the one or more movable components, thermal energy introduced into the one or more vessels, soluble gas introduced into the one or more vessels, or combinations thereof.

Clause 84: The method of clause 25, wherein the one or more starch foam units at least partially adhere to the substrate in the two or more first locations.

Clause 85: The method of any of clauses 25 and 84, wherein the two or more first locations are positioned on the substrate along a horizontal line.

Clause 86: The method of any of clauses 25 and 84-85, wherein there is a space between each of the two or more first locations.

Clause 87: The method of any of clauses 25 and 84-86, wherein the one or more starch foam units are deposited onto a first surface of the substrate.

Clause 88: The method of any of clauses 25 and 84-87, further comprising: placing a second substrate on top of the one or more starch foam units.

Clause 89: The method of clause 88, wherein the second substrate comprises a laminated substrate.

Clause 90: The method of clause 25, wherein causing the starch slurry to flow into the vessel is conducted via pressure.

Clause 91: The method of clause 29, wherein causing the starch slurry to flow into the one or more vessels comprises applying thermal energy, mechanical energy, or both.

Clause 92: The method of clause 67, further comprising: directing the starch slurry into a mold.

The various insulation products described herein may be recyclable, compostable, and/or curbside recyclable in many communities.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. This disclosure is intended to cover various modifications and equivalent arrangements included within the scope of the appended claims. Although specific terms are employed herein, they are used in a generic and descriptive sense only and not for purposes of limitation.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 26, 67.1, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

It is also to be understood that the mention of one or more method steps does not preclude the presence of additional method steps or intervening method steps between those steps expressly identified, nor does it preclude an alternative ordering of the steps from the order in which they are disclosed herein. Similarly, it is also to be understood that the mention of one or more components in a device or system does not preclude the presence of additional components or intervening components between those components expressly identified.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A starch slurry comprising:
a starch in an amount of between approximately 25 to 98 weight percent;
a plasticizer in an amount of between approximately 3 to 30 weight percent;
water in an amount of between approximately 5 to 60 weight percent; and
one or more agents in an amount of between approximately 1 to 10 weight percent,
wherein a bulk density of the starch slurry is between approximately 10 to 100 pounds per cubic foot.

2. The starch slurry of claim 1, wherein the one or more agents comprise one or more of a surfactant, a nucleating agent, a foaming agent, a rheology modifier, a colorant, a foam stabilizing agent, a leavening agent, or combinations thereof.

3. The starch slurry of claim 1, wherein the one or more agents comprise between approximately 3 to 7 weight percent of the starch slurry.

4. A starch slurry comprising:
a starch in an amount of between approximately 25 to 98 weight percent;
a plasticizer in an amount of between approximately 3 to 30 weight percent; and
water in an amount of between approximately 5 to 60 weight percent,
wherein a bulk density of the starch slurry is between approximately 20 to 80 pounds per cubic foot.

5. The starch slurry of claim 4, wherein the starch slurry comprises one or more of a dent starch, a chemically modified starch, a sugar, high amylose corn starch, or combinations thereof.

6. The starch slurry of claim 4, wherein the starch comprises between approximately 25 to 50 weight percent of the starch slurry.

7. The starch slurry of claim 4, wherein the water comprises between approximately 5 to 9 weight percent of the starch slurry.

8. The starch slurry of claim 4, wherein the plasticizer comprises polyvinyl alcohol (PVOH).

9. The starch slurry of claim 4, wherein the plasticizer comprises poly (butylene adipate-co-terephthalate) (PBAT).

10. The starch slurry of claim 4, wherein the plasticizer comprises polyvinyl acetate (PVA).

11. The starch slurry of claim 4, wherein the plasticizer comprises polylactic acid (PLA).

12. The starch slurry of claim 4, wherein the plasticizer comprises polyhydroxyalkanoate (PHA).

13. The starch slurry of claim 4, wherein the plasticizer comprises glycerol.

14. The starch slurry of claim 4, wherein the starch slurry consists essentially of the starch, the plasticizer, and water.

15. The starch slurry of claim 4, wherein the starch slurry is substantially free of a blowing agent.

16. The starch slurry of claim 4, wherein the starch slurry further comprises a blowing agent, and wherein the blowing agent comprises an acrylonitrile copolymer, a vinyl copolymer, or both.

17. The starch slurry of claim 4, wherein the starch slurry further comprises one or more a leavening agent, a coloring agent, a nucleation agent, a blowing agent, a stabilizing agent, a rheology agent, cellulose, or a combination thereof.

18. The starch slurry of claim 17, wherein the starch slurry further comprises:
the leavening agent comprising one or more of yeast, sodium bicarbonate, baking soda, baking powder, or a combination thereof;
the coloring agent comprising lignin, a food grade die, or both;
the nucleation agent comprising calcium carbonate (CaCO₃), talc, or both;
the blowing agent comprising one or more of a thermoplastic microsphere, an acrylonitrile copolymer, a vinyl copolymer, or combinations thereof;
the stabilizing agent comprising lecithin, protein, or both; and
the rheology agent comprising one or more of carboxymethyl cellulose (CMC), hydroxypropyl cellulose (HPMC), methylcellulose (MC), xanthan gum, guar gum, carrageenan, or combinations thereof.

19. The starch slurry of claim 18, wherein:
the leavening agent comprises between approximately 0.1 to 35 weight percent of the starch slurry;
the coloring agent comprises between approximately 0.1 to 5 weight percent of the starch slurry;
the nucleation agent comprises between approximately 0.1 to 5 weight percent of the starch slurry;
the blowing agent comprises between approximately 0.1 to 8 weight percent of the starch slurry;
the stabilizing agent comprises between approximately 0.1 to 15 weight percent of the starch slurry;
the rheology agent comprises between approximately 0.1 to 5 weight percent of the starch slurry; and
the cellulose comprises less than approximately 60 weight percent of the starch slurry.

20. A method for molding an insulation part using the starch slurry of claim 4, the method comprising:
placing a starch slurry into a die;
closing the die to form an air-tight chamber within the die, the air-tight chamber comprising the starch slurry;
increasing a first pressure within the air-tight chamber to a second pressure; and
die changing the second pressure within the air-tight chamber to a third pressure to create a molded product from the starch slurry, the molded product being in a shape of the die.

21. A method for making a foamed product using the starch slurry of claim 4, the method comprising:
creating a starch slurry of a first pressure;
injecting the starch slurry of the first pressure into a mold cavity of a mold, wherein the mold cavity is of a second pressure that is lower than the first pressure; and
releasing the mold to retrieve a foamed product,
wherein the foamed product has a bulk density of approximately 20 pounds per cubic foot or less.

22. A method for making a foamed product using the starch slurry of claim 4, the method comprising:
injecting a starch slurry into a mold; and
expanding the starch slurry to create a foamed product in a shape of the mold,
wherein expanding the starch slurry is conducted using one or more of microwave, radiofrequency (RF) energy, heat, CO2 expansion, or a combination thereof; and
wherein the foamed product has a bulk density of approximately 20 pounds per cubic foot or less.

23. A method for making an insulation part from the starch slurry of claim 4, the method comprising:
placing a starch slurry onto a substrate;
transporting the starch slurry and substrate through an energy source; and
heating the starch slurry as the starch slurry and the substrate are transported through the energy source to form a composite of a thin foam on the substrate.

24. A method for making an insulation part from the starch slurry of claim 4, the method comprising:
mixing a starch slurry with one or more expansion reaction compounds to create a mixture;
heating the mixture to create a pre-conditioned mixture in a gelatinized form;
placing the pre-conditioned mixture on a substrate; and
moving the pre-conditioned mixture on the substrate until the one or more expansion reaction compounds react thereby creating a composite of a thin foam on the substrate.

25. A method of making an insulation panel from the starch slurry of claim 4, the method comprising:
causing a starch slurry to flow into a vessel;
placing a substrate on an apparatus; and
simultaneously, to generate the insulation panel:
moving the apparatus to transport the substrate; and
actuating a movable component of the vessel thereby extruding the starch slurry through an aperture of the vessel to deposit one or more starch foam units onto the substrate in each of two or more first locations spaced apart from one another.

26. A method of making an insulation part, the method comprising:
mixing a starch, a plasticizer, and water together to form a starch slurry;
depositing the starch slurry onto a substrate; and
expanding the starch slurry to create a foam layer on the substrate.

27. The method of claim 26, further comprising mixing one or more expansion reaction compounds into the starch slurry, wherein expanding the starch slurry comprises reacting the one or more expansion reaction compounds using one or more of microwave, radiofrequency (RF) energy, heat, CO₂ expansion, or a combination thereof.

28. The method of claim 26, wherein the starch slurry is deposited on an entire surface of the substrate.

29. A method of depositing a starch foam, the method comprising:
mixing at least a starch, a plasticizer, and water together to form a starch slurry;
causing the starch slurry to flow into one or more vessels;
actuating one or more movable components of the one or more vessels thereby extruding the starch slurry through one or more apertures of the one or more vessels to generate a starch foam; and
moving at least a portion of the one or more vessels, a substrate, or both to dispose the starch foam in a plurality of positions that are spaced apart from one another on the substrate.

30. The method of claim 29, wherein:
the starch comprises between approximately 25 to 98 weight percent of the starch slurry;
the plasticizer comprises between approximately 3 to 30 weight percent of the starch slurry;
the water comprises between approximately 5 to 60 weight percent of the starch slurry; and
wherein the starch foam has a bulk density of approximately 20 pounds per cubic foot or less.
